(19) United States
(12) Patent Application Publication
(10) Pub. No.: US 2026/0146661 A1
(43) Pub. Date: May 28, 2026

(54) FILM RIDING DAMPERS FOR ROTATING COMPONENTS

(71) Applicant: General Electric Company, Evendale, OH (US)

(72) Inventors: Rahul A. Bidkar, Clifton Park, NY (US); Bugra H. Ertas, Niskayuna, NY (US); Keith William Gary, Niskayuna, NY (US); David Raju Yamarthi, Bangalore (IN); Ravindra Shankar Ganiger, Bangalore (IN); Prateek Jalan, Bangalore (IN)

(21) Appl. No.: 18/958,787

(22) Filed: Nov. 25, 2024

(51) Int. Cl. F16F 15/14; F01D 25/04

(52) U.S. Cl. CPC F16F 15/145; F01D 25/04; F05D 2260/96; F16F 2222/08; F16F 2232/02; F16F 2236/08

(57) ABSTRACT

Film riding dampers for rotating components are disclosed herein. An example damper assembly for a rotor includes a body including a first surface to form a first thin-film interface with the rotor, and a second surface to form an interface with a stator, and a damper rigidly coupled to the body including a casing including a damping medium and a plunger within the casing.

### FIELD OF THE DISCLOSURE

This disclosure relates generally to vibration dampers and, more particularly, to film riding dampers for rotating components.

### BACKGROUND

Gas turbine engines, such as turbofan engines, may be used for aircraft propulsion. A turbofan engine generally includes a bypass fan section and a turbomachine such as a gas turbine engine to drive the bypass fan. The turbomachine generally includes a compressor section, a combustion section, and a turbine section in a serial flow arrangement. The compressor section and the turbine section are driven by one or more rotor shafts and generally include multiple rows or stages of rotor blades coupled to the rotor shaft. A row of rotor blades is axially spaced from a successive row of rotor blades by a respective row of stator or stationary vanes. A radial gap is formed between an inner surface of the stator vanes and an outer surface of the rotor shaft.

### BRIEF DESCRIPTION OF THE DRAWINGS

FIG. 1 is a schematic cross-sectional view of an example high-bypass turbofan-type gas turbine engine in which examples disclosed herein may be implemented.

FIG. 2 is a cross-sectional view of an example damper assembly that may be implemented in the example gas turbine engine of FIG. 1.

FIG. 3A is a cross-sectional view of an example damper assembly segment of FIG. 2 taken along line A-A of FIG. 2.

FIG. 3B is a cross-sectional view of a second example damper segment including a plurality of flexible conduits.

FIG. 3C is a cross-sectional view of a third example damper segment including a garter spring.

FIG. 4 is a schematic diagram of a damper assembly segment of FIG. 3A and the rotor 202.

FIG. 5A is a cross-sectional side schematic diagram of a damper of FIG. 3A.

FIG. 5B is a cross-sectional top schematic diagram of a damper of FIG. 3A.

FIG. 6 is an example alternative configuration of the damping casing and the damping plunger that can be used with the damper assembly of FIG. 2.

FIG. 7 is a cross-sectional view of another example damper that may be implemented in the example gas turbine engine of FIG. 1 and implemented in accordance with teachings of this disclosure.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Prior rotor damping systems, such as squeeze film dampers, are limited to being mounted at a bearing location of the rotor. The incorporation of such dampers into bearings includes the soft mounting of the bearing and limits the oscillation experienced by the dampers, which reduces the efficacy of dampers. Examples disclosed herein include dampers that track the radial motion of the rotor by riding on a thin-film interface formed with the rotor. Example dampers disclosed herein can be incorporated into shaft seals and/or be independent therefrom. Example dampers disclosed herein include hermetic liquid-filled dampers mounted to a seal segment, which are rigidly mounted to the damper body and move with the vibration and radial oscillation of the rotor. Example dampers disclosed herein include plungers inside the rigid casing, which undergo motion relative to the casing and damp the motion of the rotor. Example dampers disclosed herein are not limited to being incorporated into bearing locations and can be mounted at mid-span locations on the rotor that experience comparatively high magnitudes of radial motion. Some example hermetic-sealed dampers disclosed herein do not require special handling protocols and/or static seals.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

During operation, rotating components (referred to herein as “rotors”), such as the shafts of gas turbine engines, vibrate and radially oscillate. Such oscillations can cause the rotor to radially travel. At high levels of oscillation, the rotor can contact and potentially damage other components disposed around the rotor. The magnitude of oscillation, particularly when the rotor speed is at or near a critical speed of the rotor, depends on the damping of the rotor. As used herein, the “critical speed” of a rotating component is the angular speed at which the rotating device exhibits resonance. That is, when a rotor is rotating at or near critical speeds, the oscillation of the rotor is almost entirely dependent on the damping of the rotor. Conversely, the magnitude of oscillation at non-critical rotor speeds is more dependent on the stiffness and/or inertia associated with the rotor than the damping of the rotor. The magnitude of oscillation of the rotor is typically higher when the rotor is at critical speeds than non-critical speeds.

Prior damping systems for rotors, such as squeeze film dampers, are limited to being incorporated into the bearing locations of the rotor. Because rotors are constrained at bearings, the oscillation and/or vibration amplitude of rotors at bearing locations is comparatively small and the squeeze film damping associated therewith is accordingly limited. Additionally, the incorporation of squeeze film dampers into bearing locations necessitates the soft mounting of the bearing to stationary portions (referred to herein as “stators”). As used herein, a “rotor mode shape” is the deformation (e.g., oscillation, vibration, etc.) profile of a rotor at critical speeds. For rotors with rotor modes shapes characterized with large vibrations amplitudes located away from the bearing locations, the packaging restrictions of prior squeeze film dampers are unable to efficiently damp such rotors.

Examples disclosed herein overcome the above-noted deficiencies and include film riding dampers that interface directly with rotors at non-bearing locations. The damper assemblies disclosed herein include a damper body, which travels with the vibration of the rotor, and a damper rigidly coupled thereto. Some such damper assemblies disclosed herein include hermetically sealed casings with a damping medium and a plunger that is coupled to an interior of the casing via one or more springs. In some such examples disclosed herein, the relative movement of the casing and the plunger disposed dissipates energy from the vibration of the rotor and provides a damping force thereto. Some example dampers disclosed herein are hermetically sealed and do not include elastomer seals or require complicated handling protocols. Other example dampers disclosed herein include a body and a plunger that is rigidly coupled to the body and extends therefrom into a damping medium of the damper. Some example damper assemblies disclosed herein are not limited to being incorporated into bearing locations and can be coupled to the rotor at any span-wise location with a high magnitude of oscillation, which increases the efficacy of the damper assemblies disclosed herein. Some example damper assemblies disclosed herein are film-riding seals that mitigate leakage of air from a therethrough.

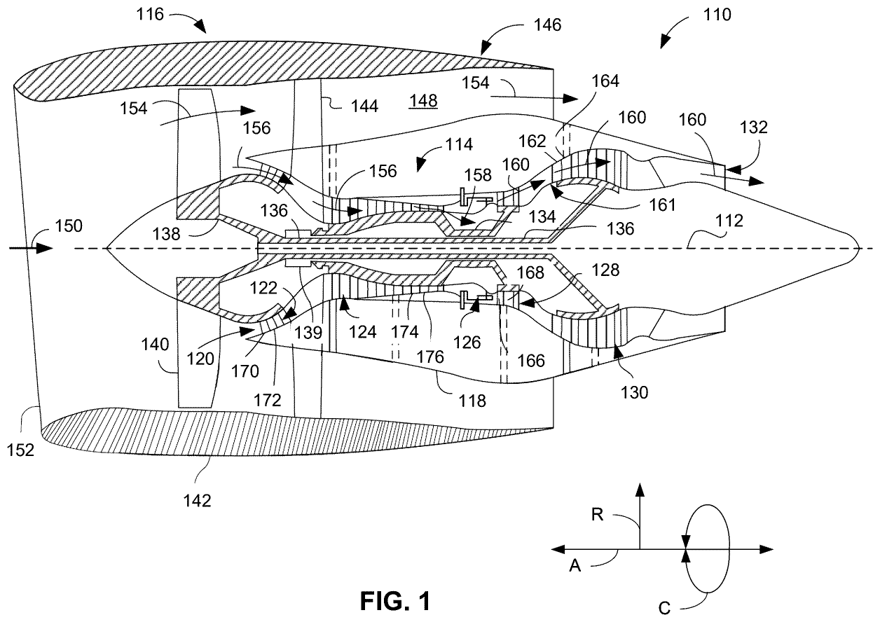

Referring now to the drawings, wherein identical numerals indicate the same elements throughout the figures, FIG. 1 is a schematic cross-sectional view of an example high-bypass turbofan-type gas turbine engine 110 (“turbofan engine 110”). While the illustrated example is a high-bypass turbofan engine, the principles of the present disclosure are also applicable to other types of engines, such as low-bypass turbofans, turbojets, turboprops, propfans, etc. As shown in FIG. 1, the gas turbine engine 110 defines a longitudinal or axial centerline axis 112 extending therethrough for reference. FIG. 1 also includes an annotated directional diagram with reference to an axial direction A, a circumferential direction C, and a radial direction R.

In general, the gas turbine engine 110 includes a core turbine 114 disposed downstream from a fan section 116. The core turbine 114 includes a substantially tubular outer casing 118 that defines an annular inlet 120. The outer casing 118 can be formed from a single casing or multiple casings. The outer casing 118 encloses, in serial flow relationship, a compressor section having a booster or low-pressure compressor 122 (“LP compressor 122”) and a high pressure compressor 124 (“HP compressor 124”), a combustion section 126, a turbine section having a high pressure turbine 128 (“HP turbine 128”) and a low-pressure turbine 130 (“LP turbine 130”), and an exhaust section 132. A high pressure shaft or spool 134 (“1P shaft 134”) drivingly couples the HP turbine 128 and the HP compressor 124. A low-pressure shaft or spool 136 (“LP shaft 136”) drivingly couples the LP turbine 130 and the LP compressor 122. The LP shaft 136 can also couple to a fan spool or shaft 138 of the fan section 116. In some examples, the LP shaft 136 is coupled directly to the fan shaft 138 (e.g., a direct-drive configuration). In alternative configurations, the LP shaft 136 can couple to the fan shaft 138 via a reduction gear 139 (e.g., an indirect-drive or geared-drive configuration).

As shown in FIG. 1, the fan section 116 includes a plurality of fan blades 140 coupled to and extending radially outwardly from the fan shaft 138. An annular fan casing or nacelle 142 circumferentially encloses the fan section 116 and/or at least a portion of the core turbine 114. The nacelle 142 can be supported relative (e.g., partially supported, etc.) to the core turbine 114 by a plurality of circumferentially-spaced apart outlet guide vanes 144. Furthermore, a downstream section 146 of the nacelle 142 can enclose an outer portion of the core turbine 114 to define a bypass airflow passage 148 therebetween.

As illustrated in FIG. 1, air 150 enters an inlet portion 152 of the gas turbine engine 110 during operation thereof. A first portion 154 of the air 150 flows into the bypass airflow passage 148, while a second portion 156 of the air 150 flows into the inlet 120 of the LP compressor 122. One or more sequential stages of LP compressor stator vanes 170 and LP compressor rotor blades 172 coupled to the LP shaft 136 progressively compress the second portion 156 of the air 150 flowing through the LP compressor 122 en route to the HP compressor 124. Next, one or more sequential stages of HP compressor stator vanes 174 and HP compressor rotor blades 176 coupled to the HP shaft 134 further compress the second portion 156 of the air 150 flowing through the HP compressor 124. This provides compressed air 158 to the combustion section 126 where it mixes with fuel and burns to provide combustion gases 160.

The combustion gases 160 flow through the HP turbine 128 where one or more sequential stages of HP turbine stator vanes 166 and HP turbine rotor blades 168 coupled to the HP shaft 134 extract a first portion of kinetic and/or thermal energy therefrom. This energy extraction supports operation of the HP compressor 124. The combustion gases 160 then flow through the LP turbine 130 where one or more sequential stages of LP turbine stator vanes 162 and LP turbine rotor blades 164 coupled to the LP shaft 136 extract a second portion of thermal and/or kinetic energy therefrom. This energy extraction causes the LP shaft 136 to rotate, thereby supporting operation of the LP compressor 122 and/or rotation of the fan shaft 138. The combustion gases 160 then exit the core turbine 114 through the exhaust section 132 thereof. A turbine frame 161 with a fairing assembly is located between the HP turbine 128 and the LP turbine 130. The turbine frame 161 acts as a supporting structure, connecting a high-pressure shaft's rear bearing with the turbine housing and forming an aerodynamic transition duct between the HP turbine 128 and the LP turbine 130. Fairings form a fluid pathway between the high-pressure and low-pressure turbines and can be formed using metallic castings (e.g., nickel-based cast metallic alloys, etc.).

Along with the gas turbine engine 110, the core turbine 114 serves a similar purpose and is exposed to a similar environment in land-based gas turbines, turbojet engines in which the ratio of the first portion 154 of the air 150 to the second portion 156 of the air 150 is less than that of a turbofan, and unducted fan engines in which the fan section 116 is devoid of the nacelle 142. In each of the turbofan, turbojet, and unducted engines, a speed reduction device (e.g., the reduction gear 139) can be included between any shafts and spools. For example, the reduction gear 139 is disposed between the LP shaft 136 and the fan shaft 138 of the fan section 116.

As described above with respect to FIG. 1, the turbine frame 161 is located between the HP turbine 128 and the LP turbine 130 to connect the high-pressure shaft's rear bearing with the turbine housing and form an aerodynamic transition duct between the HP turbine 128 and the LP turbine 130. As such, air flows through the turbine frame 161 between the HP turbine 128 and the LP turbine 130.

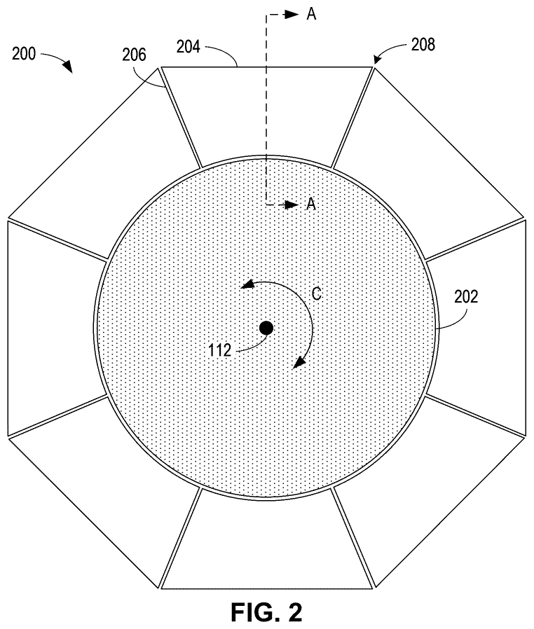

FIG. 2 is a cross-sectional view of an example damper assembly 200 that may be implemented in the example gas turbine engine 110 of FIG. 1. In the illustrated example of FIG. 2, the damper assembly 200 is disposed about a rotor 202. In some examples, the rotor 202 is an example shaft of the gas turbine engine 110 (e.g., the LP shaft 136 of FIG. 1, the fan shaft 138 of FIG. 1, the HP shaft 134 of FIG. 1, etc.). In other examples, the rotor 202 can be implemented by a different type of rotating component (e.g., the shaft of another vehicle, the shaft of a piece of industrial machinery, the shaft of a pump, a camshaft, a rotating disk, a flywheel, etc.). That is, the damper assembly 200 can be used in conjunction with any devices that include rotating components. In some examples, the damper assembly 200 functions as a seal. That is, the damper assembly 200 can inhibit the flow of gas axially along the rotor 202 and defines an axial pressure differential over the damper segments 204. In other examples, the damper assembly 200 is not a seal and the damper assembly 200 does not define a pressure differential thereover.

In the illustrated example of FIG. 2, the damper assembly 200 includes eight damper segments (e.g., the damper segments 204, etc.) that are evenly distributed about the circumference of the rotor 202. In other examples, the damper assembly 200 can include a different quantity of damper segments (e.g., two segments, three segments, four segments, eight segments, ten segments, etc.). Additionally or alternatively, some or all of the damper segments 204 can have different sizes and/or shapes. In some such examples, the damper segments 204 are unevenly distributed about the rotor 202.

In the illustrated example of FIG. 2, the adjacent ones of the damper segments 204 include side surfaces 206 that have a circumferential gap 208 defined therebetween. Additionally or alternatively, adjacent ones of the damper segments 204 are coupled together at one or more locations along the side surfaces 206 (e.g., edges, etc.) of the damper segments 204. For example, the damper segments 204 can be coupled in a manner that enables independent radial motion of the damper segments 204 (e.g., coupled in a way that enables different ones of the damper segments 204 can simultaneously have different radial displacements from the rotor 202, etc.). In some examples, each of the damper segments 204 can be disposed within a frame that surrounds the rotor 202.

In the illustrated example of FIG. 2, the damper assembly 200 includes an interior surface 209 that is adjacent to the rotor 202 (e.g., each of the damper segments 204 defines a portion of the interior surface 209, etc.). In the illustrated example of FIG. 2, the interior surface 209 of the damper assembly 200 is spaced from the rotor 202 and defines a radial gap 210 between the rotor 202 and the damper assembly 200. In the illustrated example of FIG. 2, the damper assembly 200 generates a first thin-film interface 212 (e.g., a thin film of pressurized gas, etc.) between the rotor 202 and the damper assembly 200. In some such examples, each of the damper segments 204 expels pressurized air from the interior surface 209 into the radial gap 210.

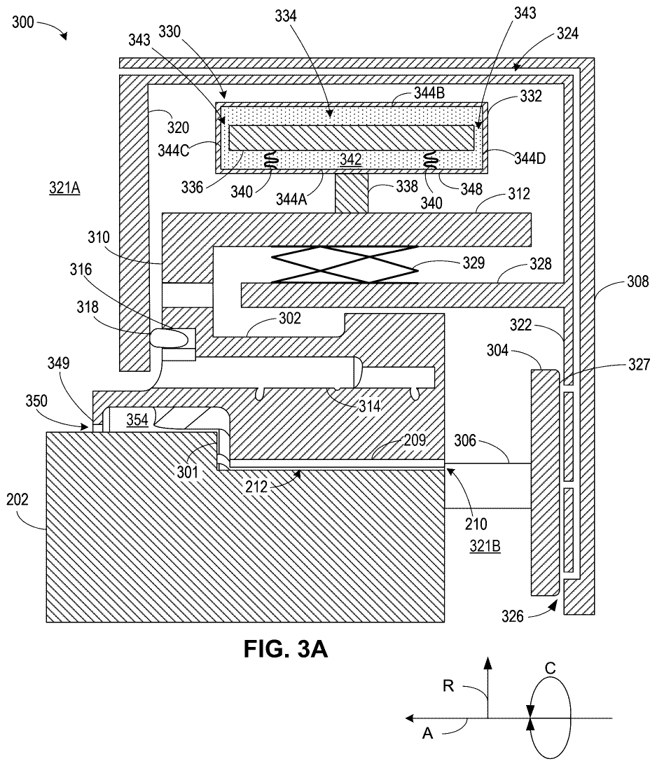

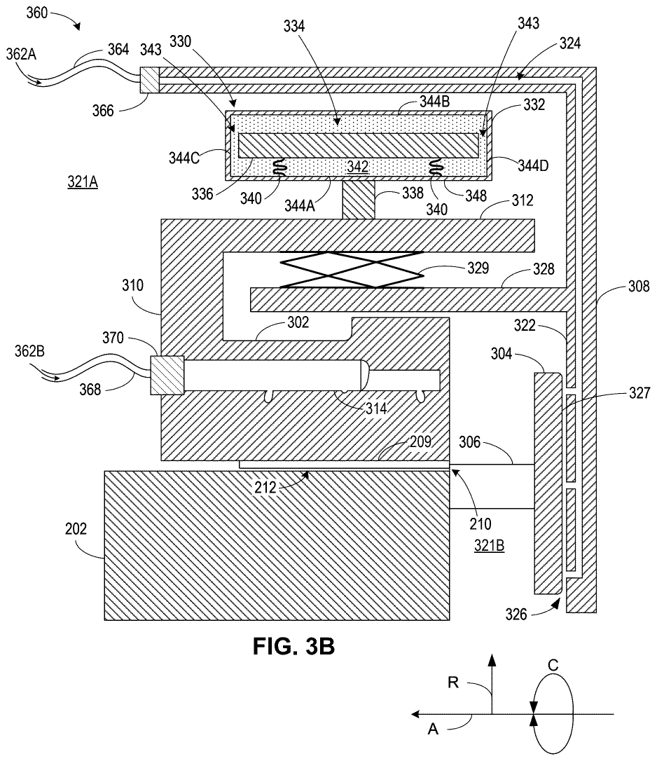

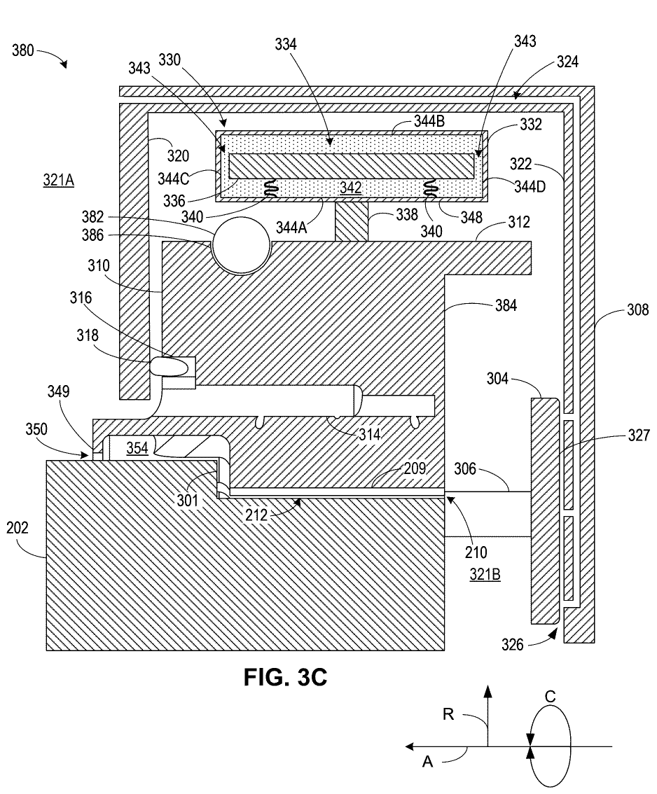

The first thin-film interface 212 reacts radial forces transmitted between the rotor 202 and the damper assembly 200 and does not react forces transmitted in the axial and/or circumferential directions. As such, the first thin-film interface 212 does not inhibit the rotation of the rotor 202 in the circumferential direction C about the centerline axis 112 of FIG. 1 (e.g., extending out of the page in FIG. 2). In some examples, the damper assembly 200 can generate additional thin-film interfaces with other components (e.g., a stator). In some such examples, the additional thin-film interfaces can inhibit the axial translation of the damper assembly 200 to maintain a separation between the stator and the damper segments 204. In the illustrated example of FIG. 2, the first thin-film interface 212 can maintain a separation between the rotor 202 and the damper segments 204 to reduce friction therebetween and, as a result, reduce wear of the damper segments 204 and/or the rotor 202 during the operation of the gas turbine engine 110. The first thin-film interface 212 is described in additional detail below in conjunction with FIG. 3A.

FIG. 3A is a cross-sectional view of an example damper segment 300 that can implement one of the damper segments 204 of FIG. 2. The cross-sectional view of FIG. 3A is taken along the line A-A of FIG. 2. In the illustrated example of FIG. 3A, the rotor 202 includes a rotor flange 301. In other examples, the rotor flange 301 is absent. In the illustrated example of FIG. 3A, the damper segment 300 includes a damper body 302 (also referred to herein as a “body”), an interface plate 304, and a member 306 extending therebetween. In the illustrated example of FIG. 3A, the damper segment 300 is adjacent to a stator 308.

In the illustrated example of FIG. 3A, the damper body 302 includes an arm 310 extending from the damper body 302, a damper flange 312 extending from the arm 310, and internal conduit(s) 314 formed within the damper body 302. As used herein, “an internal conduit” is a flow path that is formed within the negative space of a rigid component, such as the damper body 302 and/or the stator 308. In the illustrated example of FIG. 3A, the damper segment 300 includes a slot 316 in the arm 310 and a piston bar 318 disposed therein. In the illustrated example of FIG. 3A, the damper segment 300 is disposed between a first region 321A and a second region 321B. In the illustrated example of FIG. 3A, the damper body 302, the interface plate 304, and the member 306 are depicted as a single integral component. In some such examples, the damper segment 300 can be manufactured via additive manufacturing and/or negative machining. In other examples, one or more of the damper body 302, the interface plate 304, and the member 306 can be manufactured as distinct components and subsequently assembled in the damper segment 300. The member 306 extends between the damper body 302 and the interface plate 304. In the illustrated example of FIG. 3A, the member 306 is a rigid member such that the interface plate 304 is rigidly coupled to the damper body 302 (e.g., the interface plate 304 radially travels with the damper body 302, etc.). As used herein, a component is “rigid,” when the component has a geometry resistant to deformation (e.g., the component is not configured as a spring, etc.) and is composed of material(s) with comparatively high moduli of elasticity, such as metals (e.g., aluminum, steel, titanium, nickel-based alloys, etc.), composites (e.g., reinforced plastics, ceramic composites, carbon composites, etc.), and similar materials. As used herein, two components are “rigidly coupled” when no relative motion occurs between the components other than the strain of the components and any rigid components disposed therebetween. In some such examples, the member 306 is configured to enable the flexural bending thereof (e.g., the member 306 is comparatively thinner than the damper body 302, etc.), which enables relative motion between the damper body 302 and the interface plate 304.

The stator 308 is a stationary (e.g., non-rotating, etc.) portion of the machinery that includes the rotor 202 of FIG. 2 and the damper assembly 200 of FIG. 2. For example, if the damper assembly 200 is disposed within the gas turbine engine 110 of FIG. 1, the stator 308 can be a portion of the case of the gas turbine engine 110 housing the rotor 202, a stationary disk disposed around the rotor 202, etc. Additionally or alternatively, the stator 308 can be implemented by a seal housing, a carrier, and/or another stationary structure. In the illustrated example of FIG. 3A, the stator 308 is positioned proximate to and partially surrounds the damper segment 300. In the illustrated example of FIG. 3A, the stator 308 includes a first stator surface 320, which is adjacent to the arm 310 and abuts the piston bar 318. In some examples, the piston bar 318 and the first thin-film interface 212, seals (e.g., restricts a flow of fluid, etc.) between the first region 321A and the second region 321B (e.g., between the damper body 302 and the first stator surface 320, etc.). The piston bar 318 may be implemented by an elastomer, a metal, and/or a flexible member that is disposed within the slot 316 via an interface fit.

In the illustrated example of FIG. 3A, the stator 308 includes a second stator surface 322 opposite the first stator surface 320. In the illustrated example of FIG. 3A, the second stator surface 322 is adjacent to (e.g., proximate to, etc.) the interface plate 304. In the illustrated example of FIG. 3A, the stator 308 includes a second internal conduit(s) 324, which extend through the stator 308 and fluidly couple the first region 321A and the second region 321B. The second internal conduit(s) 324 direct air through the stator 308 and out of holes on the second stator surface 322. The high-pressure air flowing through the second internal conduit(s) 324 forms a second thin-film interface 326 between the second stator surface and an interface plate surface 327. The second thin-film interface 326 opposes axial forces to maintain separation between the stator 308 and the damper segment 300, which reduces frictional forces in the radial direction therebetween. The second thin-film interface 326 facilitates the radial motion of the damper body 302. In some examples, if the damper segment 300 is a seal and there is a pressure differential between the first region 321A and the second region 321B, air is forced through the second internal conduit(s) 324 via the pressure differential therebetween. In some such examples, the force associated with the pressure differential between the regions 321A, 321B and associated with the second thin-film interface 326 maintains the axial position of the damper segment 300 and the rotor 202 (e.g., the second thin-film interface 326 axially locates the damper segment 300, etc.). In other examples, if the damper assembly 200 is not a seal, the second internal conduit(s) 324 can be coupled to a pressurized air source (e.g., a bleed flow of the gas turbine engine 110, a compressor, etc.), which can similarly generate the second thin-film interface 326.

FIG. 3B is a cross-sectional view of an example second damper segment 360 including a first pressurized air source 362A and a second pressurized air source 362B. The second damper segment 360 of FIG. 3B is similar to the damper segment 300 of FIG. 3A, except as noted otherwise. The same reference labels correspond to the same or similar parts in FIGS. 3A and 3B. In the illustrated example of FIG. 3B, the first pressurized air source 362A feeds (e.g., provides pressurized air to, etc.) a first tube 364 (e.g., a first feed tube, a first flexible tube). The first tube 364 is fluidly coupled to the second internal conduit(s) 324 via a first connector 366. In the illustrated example of FIG. 3B, the second pressurized air source 362B feeds (e.g., provides pressurized air to, etc.) a second tube 368 (e.g., a second feed tube, a second flexible tube). The second tube 368 is fluidly coupled to the first internal conduit(s) 314 via a second connector 370. In some examples, the first pressurized air source 362A and the second pressurized air source 362B can correspond to the same or difference sources (e.g., a bleed of the gas turbine engine 110 of FIG. 1, an independent compressor, etc.). In the illustrated example of FIG. 3B, the first region 321A and the second region 321B are at substantially the same pressure (e.g., a first pressure, etc.). In some such examples, a second pressure of the first pressurized air source 362A and a third pressure of the second pressurized air source 362B are greater than the first pressure of the regions 321A, 321B.

Returning to FIG. 3A, the first thin-film interface 212 and the second thin-film interface 326 are substantially orthogonal (e.g., the first thin-film interface 212 is parallel to the axial axis and the second thin-film interface 326 is parallel to the radial axis, etc.). In some examples, the second internal conduit(s) 324 and the second thin-film interface 326 may be absent. In some examples, the interface between the interface plate surface 327 of the interface plate 304 and the second stator surface 322 can be implemented via one or more flexible members (e.g., elastomers, springs, etc.). In some such examples, the stator 308 and the damper segment 300 can include an additional interface to axially locate the damper segment 300.

In the illustrated example of FIG. 3A, the stator 308 includes a stator flange 328 that extends from the second stator surface 322. The stator flange 328 extends parallel to the damper flange 312 of the damper segment 300 toward the arm 310. In the illustrated example of FIG. 3A, the damper segment 300 further includes a spring 329, which extends between the damper flange 312 of the damper segment 300 and a stator flange 328 of the stator 308. The spring 329 supports the damper segment 300 and elastically couples the damper segment 300 to the stator 308. The spring 329 applies a radial force on the stator 308 and the damper segment 300, which radially locates the damper segment 300 and maintains the radial gap 210 between the damper body 302 and the rotor 202. In some examples, the spring 329 is a coil spring, which exerts a positive radial force on the damper segment 300 and biases the damper segment 300 away from the rotor 202. In some such examples, the spring 329 can be disposed radially inward of the stator flange 328. In other examples, one or more different types of springs (e.g., a garter spring, etc.) can be used in addition to or instead of the spring 329 of FIG. 3A.

FIG. 3C is a cross-sectional view of an example third damper segment 380 including a garter spring 382. The third damper segment 380 of FIG. 3C is similar to the damper segment 300 of FIG. 3A, excepted as noted otherwise. The same reference labels correspond to the same or similar parts in FIGS. 3A and 3C. In the illustrated example of FIG. 3C, the third damper segment 380 includes an example damper body 384, which includes a groove 386 (e.g., a garter spring groove, etc.) to receive and/or allow the seating of the garter spring 382. In some examples, the garter spring 382 can extend between a plurality of damper segments 204 of the damper assembly 200 of FIG. 2 (e.g., in the circumferential direction C, etc.) to pull and/or bias the multiple damper segments radially inward toward the rotor 202. Unlike the spring 329 of FIG. 3A that connects the damper body 302 (e.g., via the damper flange 312) with the stator 308 (e.g., via the stator flange 328), in the illustrated example of FIG. 3C, the garter spring 382 couples adjacent ones of the damper segments 204 (e.g., in the circumferential direction C). In the illustrated example of FIG. 3C, the garter spring 382 does not exert a spring force connection between the third damper segment 380 and the stator 308.

Returning to FIG. 3A, the first internal conduit(s) 314 direct air through the damper body 302 and out of holes on the interior surface 209. It should be appreciated that the first internal conduit(s) 314 of the damper body 302 includes additional flow paths that extend to the interior surface 209 that are not visible in the cross-section of FIG. 3A. The high-pressure air flowing through the first internal conduit(s) 314 forms the first thin-film interface 212 of FIG. 2. The first thin-film interface 212 enables radial forces to be transmitted between the damper body 302 and the rotor 202 and maintains the radial gap 210 therebetween. That is, the first thin-film interface 212 enables the damper body 302 of the damper segment 300 to travel with the radial movement of the rotor 202 (e.g., from the vibration of the rotor 202, etc.), prevents direct abutment of the damper segment 300 and the rotor 202, and does not inhibit the rotation of the rotor 202. In some examples, if the damper assembly 200 is a seal and there is a pressure differential between the first region 321A and the second region 321B, air is forced through the first internal conduit(s) 314 via the pressure differential. In other examples, if the damper assembly 200 is not a seal, the first internal conduit(s) 314 can be coupled to a pressurized air source (e.g., a bleed flow of the gas turbine engine 110, a compressor, etc.) via a flexible conduit (e.g., elastomer tubing, corrugated tubing, strip-wound tubing, etc.) (e.g., as discussed above in connection with FIG. 3B). In some such examples, the flexible conduit facilitates the radial travel of the damper segment 300.

Vibration and/or radial travel of the rotor 202 may occur during the operation thereof. For example, when the rotor 202 rotates in the circumferential direction C, the rotor 202 can expand (e.g., in the radial direction R) as a result of centrifugal growth and/or changes in temperature of the rotor 202. Additionally or alternatively, a radial dimension of the rotor 202 can vary in the circumferential direction C (e.g., as a result of manufacturing tolerances and/or misalignment between components of the gas turbine engine 110), which can cause the rotor 202 to vibrate during operation. Additionally or alternatively, if the rotor 202 is a component of the gas turbine engine 110, the variations of flow of gas through the gas turbine engine 110 can similarly cause the rotor 202 to vibrate. In some examples, the rotor 202 may vibrate due to unbalanced rotating weight about the axial direction A. The first thin-film interface 212 and the spring 329 enable the damper body 302 of the damper segment 300 to track and/or ride on a surface of the rotor 202 and vibrations of the rotor 202 to be transferred to the damper segment 300.

To damp vibrations transferred from the rotor 202, the damper segment 300 includes an example damper 330 implemented in accordance with teachings of this disclosure. In the illustrated example of FIG. 3A, the damper 330 includes a casing 332 defining a chamber 334, a plunger 336, a member 338, and a plurality of damper springs 340. In the illustrated example of FIG. 3A, the chamber 334 is filled with a damping medium 342. In the illustrated example of FIG. 3A, gaps 343 are defined between the plunger 336 and the casing 332. In the illustrated example of FIG. 3A, the chamber 334 includes a first interior surface 344A (e.g., a bottom interior surface, a radially inward interior surface, etc.), a second interior surface 344B (e.g., a top interior surface, a radially outward interior surface, etc.), a third interior surface 344C (e.g., a first axial interior surface, etc.), and a fourth interior surface 344D (e.g., a second axial interior surface, etc.).

In the illustrated example of FIG. 3A, the chamber 334 is defined by the interior surface of the casing 332 (e.g., the interior surfaces 344A, 344B, 344C, 344D, etc.) and is filled with the damping medium 342. In the illustrated example of FIG. 3A, the casing is enclosed (e.g., closed off on all sides, etc.). In some examples, the casing 332 is hermetically sealed. That is, air from the ambient environment of the damper 330 (e.g., air from the second region 321B, etc.) is unable to enter the chamber 334 and the damping medium 342 is unable to exit the chamber 334. In some examples, the casing 332 is a single monolithic part (e.g., manufactured via additive manufacturing, etc.) and the plunger 336, the damping medium 342, and the damper springs 340 are disposed therein during manufacturing. In other examples, the casing 332 can be a multicomponent assembly that includes one or more seals to prevent the flow of air into the chamber 334 and/or the flow of the damping medium 342 out of the chamber 334. In other examples, the casing 332 can include one or more openings such that the chamber 334 and the second region 321B are in fluid communication.

In the illustrated example of FIG. 3A, the damping medium 342 is disposed within the casing 332. The damping medium 342 resists relative movement of the plunger 336 and the casing 332 and dissipates energy therefrom. In some examples, the damping medium 342 is a liquid (e.g., oil, water, a silicone-based damping fluid, etc.). In other examples, the damping medium 342 can be a gas (e.g., ambient air, pressurized gas, etc.), an oil, a hydraulic fluid, an aerogel, and/or a particulate solid (e.g., a powder, etc.).

The plunger 336 is a generally planar member that is configured to move within the chamber 334. During operation and movement of the casing 332, the damper springs 340 transfer energy to the plunger 336, which causes the plunger 336 to move within the casing 332. The plunger 336 is disposed within the chamber 334. In the illustrated example of FIG. 3A, the plunger 336 has a same shape (e.g., rectangular, etc.) as the casing 332 and the chamber 334. In other examples, the plunger 336 can have a different shape than the casing 332 and/or the chamber 334. For example, the edges of the plunger 336 can be rounded, filleted, chamfered, and/or other smoothed. Additionally or alternatively, the surfaces of the plunger 336 can be treated (e.g., smoothed, roughened, etc.) to modify the friction associated with the flow of the damping medium 342 over the plunger 336. In the illustrated example of FIG. 3A, the position of the plunger 336 within the chamber 334 forms the gaps 343 between the third interior surface 344C and the fourth interior surface 344D. In some examples, one or both of the gaps 343 are absent (e.g., the plunger 336 abuts or nearly abuts one or both of the interior surfaces 344C, 344D, etc.). In some such examples, the plunger 336 can include one or more openings (e.g., through holes, etc.) to enable the damping medium 342 to flow therethrough.

The member 338 is a rigid member (e.g., an arm, a rod, etc.) that extends between the damper flange 312 and an exterior surface 348 of the casing 332. The member 338 rigidly couples the damper flange 312 to the casing 332. The rigid coupling of the damper body 302 and the casing 332 via the member 338 causes the casing 332 to travel with the radial movement of the damper body 302 and the rotor 202 (e.g., radial vibration is transferred from the rotor 202 to the damper body 302 via the first thin-film interface 212, etc.). In some examples, the member 338 is integral with the casing 332 and/or is integral with the damper flange 312. In some such examples, the member 338 can be coupled to the casing 332 and/or the damper flange 312 via one or more welds, one or more fasteners, and/or one or more interference fits, etc. In other examples, the casing 332, the damper body 302, and the member 338 are a single monolithic component (e.g., manufactured via additive manufacturing, etc.).

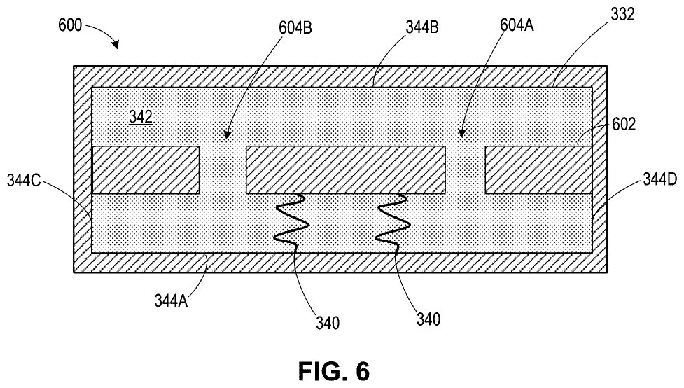

The damper springs 340 couple the plunger 336 to the casing 332 and transfer radial forces from the casing 332 to the plunger 336. The non-rigid coupling of the plunger 336 to the casing 332 (e.g., via the damper springs 340, etc.) causes the radial motion of the plunger 336 to be different than the radial motion of the casing 332. That is, the damper springs 340 cause the plunger 336 to have a radial motion relative to the casing 332 (e.g., the movement of the plunger 336 lags the movement of the other components of the damper segment 300, etc.). In the illustrated example of FIG. 3A, the damper springs 340 are coil springs. In other examples, one or more of the damper springs 340 can be implemented by a different type of spring(s) (e.g., a helical spring, a leaf spring, a disc spring, a flat spring, etc.). In the illustrated example of FIG. 3A, the damper springs 340 extend from the first interior surface 344A to the plunger 336. In other examples, one or both of the damper springs 340 extend from the second interior surface 344B to the plunger 336. In the illustrated example of FIG. 3A, the damper 330 includes two springs (e.g., the damper springs 340, etc.) that extend from the first interior surface 344A. In other examples, the damper 330 includes one spring and/or more than two springs that extend from one or both of the interior surfaces 344A, 344B to the plunger 336. While one example internal configuration of the damper 330 is depicted in the FIG. 3A (e.g., the geometric configuration of the casing 332, the plunger 336, the damper springs 340, and the gaps 343, etc.), it should be appreciated that the damper 330 can have other internal configurations. Another example internal configuration of the damper 330 is described below in conjunction with FIG. 6.

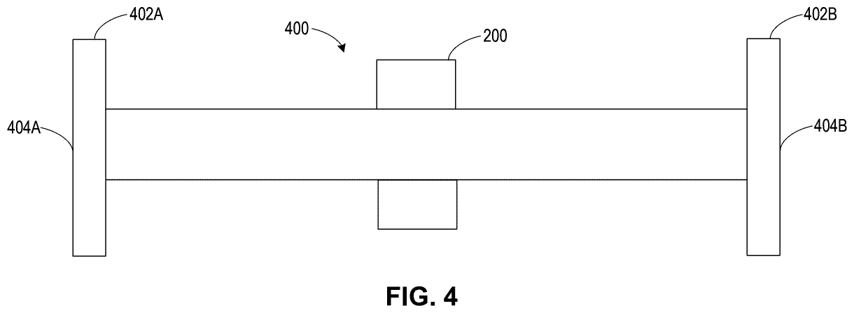

The rigid radial coupling of the casing 332 to damper body 302 causes the casing 332 to radially move with damper body 302 and the rotor 202. As such, the vibration of the rotor 202 is transferred through damper body 302 to the casing 332. Because the plunger 336 is not rigidly coupled to the casing 332, the movement of the casing 332 relative to the plunger 336 forces the damping medium 342 around the plunger 336 and through the gaps 343. Additionally, the damper springs 340 correspondingly expand and/or contract, which exerts a spring force on the plunger 336 and prevents the plunger 336 from contacting the first interior surface 344A and the second interior surface 344B. The frictional forces and/or drag associated with the relative flow of the damping medium 342 around the plunger 336 (e.g., the movement of the plunger 336 within the damping medium 342, etc.) and the spring forces associated with the damper springs 340 causes the radial motion (e.g., vibration, etc.) of the plunger 336 to be out of phase (e.g., lagging, slightly delayed, etc.) with the radial motion of the rotor 202. The squeezing of the damping medium 342 and the associated phase lag of the plunger 336 removes energy from and damps the radial vibration of the rotor 202, which reduces the total radial travel of the rotor 202. The damping characteristics of the damper 330 are described in additional detail below in conjunction with FIG. 4.

In the illustrated example of FIG. 3A, the damper segment 300 also acts as a seal between the first region 321A and the second region 321B. That is, the damper segment 300 restricts flow and/or leakage of fluid between the first region 321A and the second region 321B (e.g., from a high-pressure region to a low-pressure region, etc.). In the illustrated example of FIG. 3A, the damper segment 300 includes a lip 349 (e.g., a tooth, a seal, etc.) that extends radially inward from the damper body 302 and defines a gap 350 between the damper body 302 and the rotor 202. In the illustrated example of FIG. 3A, the lip 349 is integral with the damper body 302. In other examples, the lip 349 is a discrete component that is coupled to the damper body 302 via one or more fasteners, one or more welds, and/or one or more interference fits, etc. During operation of the rotor 202 and the damper segment 300, flow between the first region 321A and the second region 321B is restricted by the gap 350, which causes an interior 354 between the rotor 202 and the damper body 302 to be at a lower pressure than the second region 321B. The comparatively lower pressure of the interior 354 and the second region 321B compared to the first region 321A facilitates the flow of air through the first internal conduit(s) 314 and the formation of the first thin-film interface 212. The first thin-film interface 212 and the piston bar 318 restrict (e.g., prevent, etc.) the flow of air through the damper segment 300 and enable the damper segment 300 to function as a seal.

In other examples, the damper segment 300 damps the vibration of the rotor 202 and does not seal the second region 321B from the first region 321A. For example, the regions 321A, 321B can have approximately the same pressure (e.g., there is no pressure differential between the regions 321A, 321B, etc.). In such examples, the damper segment 300 (and the entirety of the damper assembly 200 of FIG. 2, etc.) does not restrict (e.g., prevent, inhibit, etc.) the flow of air between the regions 321A, 321B. In some such examples, the damper segment 300 does not include the piston bar 318, the lip 349, and/or other features (e.g., as shown in FIG. 3B). In some examples, the damper segment 300 includes one or more flexible conduits (e.g., tubes 364, 368 of FIG. 3B, etc.) coupled to the internal conduit(s) 314, 324, which facilitates the generation of the thin-film interfaces 212, 326. In other examples, the second thin-film interface 326 is absent and the damper segment 300 can be axially located via one or more other features (e.g., fasteners, surfaces, etc.).

FIG. 4 is a schematic diagram of the damper assembly 200 of FIG. 2 and the rotor 202 of FIG. 2. In the illustrated example of FIG. 4, the damper assembly 200 is disposed at a mid-span location 400 on the rotor 202. In the illustrated example of FIG. 4, the rotor 202 is supported by a first bearing 402A and a second bearing 402B. In the illustrated example of FIG. 4, the first bearing 402A and the second bearing 402B are disposed at a first end 404A of the rotor 202 and a second end 404B of the rotor 202, respectively. The bearings 402A, 402B support the rotor 202 and transfer radial forces associated with the rotor 202 (e.g., radially forces associated with imbalances of the rotor 202, the weight of the rotor 202, etc.) to a stationary component (e.g., ground, a casing of the gas turbine engine 110 of FIG. 1, etc.). In the illustrated example of FIG. 4, the mid-span location 400 is located axially between the first bearing 402A and the second bearing 402B. That is, unlike prior dampers, the damper assembly 200 is not restricted to being incorporated into the bearings 402A, 402B. As such, the damper assembly 200 can be placed at the mid-span location 400 (e.g., a non-bearing location, etc.) on the rotor 202. In the illustrated example of FIG. 4, the mid-span location 400 is halfway between (e.g., the axial center, the middle point, etc.) the bearings 402A, 402B and the ends 404A, 404B. That is, the mid-span location 400 is equidistant between the bearings 402A, 402B and the ends 404A, 404B. In other examples, the mid-span location 400 can be disposed at any other location on the rotor 202. In some such examples, because the magnitude of radial travel is generally greater mid-span on the rotor 202 than at the ends 404A, 404B, the placement of the damper assembly 200 at a mid-span location 400 has a greater damping effect than prior dampers (e.g., squeeze film dampers, etc.) incorporated into the bearing locations of the bearings 402A, 402B.

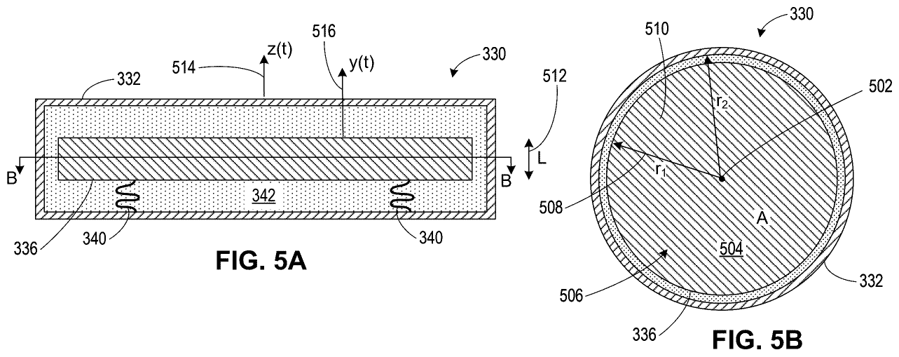

FIG. 5A is a simplified cross-sectional view schematic diagram of the damper 330 of FIG. 3A. FIG. 5A is a simplified cross-sectional view schematic diagram of the damper 330 of FIG. 3A along the B-B line of FIG. 5A. In the illustrated example of FIGS. 5A and 5B, the damper 330 includes the casing 332 of FIG. 3A, the plunger 336 of FIG. 3A, the damper springs 340 of FIG. 3A, and the damping medium 342 of FIG. 3A. In the illustrated example of FIG. 5B, the damper 330 has a vertical center 502. In the illustrated example of FIG. 5B, a top surface 504 of the plunger 336 has an area 506 (A), the plunger 336 has a first radius 508 (r₁), and the casing 332 has a second radius 510 (e.g., an inner radius) (r₂). In the illustrated example of FIG. 5A, the plunger 336 has a thickness 512 (L). In the illustrated example of FIG. 5A, the radial position of the plunger 336 is defined by the first function 514. In the illustrated example of FIG. 5A, the radial position of the casing 332 and other portions rigidly coupled thereto (e.g., the other components of the damper assembly 200 of FIG. 3A, etc.) is defined by the second function 516.

The damping coefficient of the damper 330 and the damper assembly 200 (e.g., including a plurality of segments each having the damper 330, etc.) is dependent on the material properties of the damping medium 342 (e.g., the dynamic viscosity of the damping medium 342, etc.) and the geometry of the damping segment (e.g., the area 506 of the plunger 336, the thickness 512 of the plunger 336, the first radius 508 of the plunger 336, and the second radius 510 of the casing 332, etc.). For example, the damping coefficient associated with the damper 330 is given by the following equation:

$$c = \frac{{A}^{2} 8 μ L}{π ( {r}_{2}^{2} - {r}_{1}^{2} )} [ {r}_{2}^{2} + {r}_{1}^{2} - \frac{{r}_{2}^{2} - {r}_{1}^{2}}{ln ( {r}_{2} / {r}_{1} )} ] , \qquad ( 1 )$$

where c is the damping coefficient, A is the area 506 of the plunger 336, μ is the dynamic viscosity of the damping medium 342, L is the thickness 512 of the plunger 336, r₁ is the first radius 508, and r₂ is the second radius 510.

The motion of the damper 330 is defined per the following equation:

$${m}_{plunger} \ddot{z} + c \dot{z} + {k}_{{plunger}^{Z}} = c \dot{y} + {k}_{plunger} y , \qquad ( 2 )$$

where is m_{plunger} is the mass of the plunger 336, z is the position of the plunger 336 as a function of time (e.g., the first function 514, etc.), ż is the radial velocity of plunger 336 as a function of time (e.g., the first derivative of first function 514, etc.), \ddot{z} is the radial acceleration of the plunger 336 as a function of time (e.g., the second derivative of the first function 514, etc.), c is the damping coefficient of the damper 330, k_{plunger} is the spring constant of the damper springs 340, y is the position of the casing 332 as a function of time (e.g., the second function 516, etc.), and \dot{y} is the radial velocity of the casing 332 as a function of time (e.g., the first derivative of the second function 516, etc.). In FIG. 5A, because the casing 332 is rigidly coupled to the damper body 302, y also represents a position of the damper body 302. The motion of the damper body 302 is defined per the following equation:

$$( {m}_{plunger} + {m}_{casing} ) \ddot{y} + c \dot{y} + ( {k}_{plunger} + {k}_{seal} ) y = c \dot{z} + {k}_{plunger} z + F ( t ) , \qquad ( 3 )$$

where m_{casing} is the mass of the casing 332, ÿ is the radial acceleration of the damper body 302 as a function of time (e.g., the second derivative of the second function 516, etc.), kₛₑₐₗ is the spring coefficient of the spring 329, and F(t) is the force applied by the first thin-film interface 212 on the rotor 202 and the damper body 302.

In the illustrated example of FIG. 5B, the casing 332 and the plunger 336 have circular cross-sections. In other examples, the casing 332 and the plunger 336 can have other cross-sectional geometries (e.g., ovoid, polygonal, etc.). Additionally or alternatively, the damper 330 can include a different configuration of damper springs 340. It should be appreciated that the equations (1), (2), and (3) depend on the geometry of the casing 332 and the plunger 336 and will vary if the casing 332 and the plunger 336 have a geometry different than the geometry of FIGS. 5A and 5B.

FIG. 6 is an example alternative internal configuration 600 for the damper 330 of FIG. 3A. In the illustrated example of FIG. 6, the alternative internal configuration 600 is disposed with the casing 332 of FIG. 3A, which includes the first interior surface 344A of FIG. 3A, the second interior surface 344B of FIG. 3A, the third interior surface 344C of FIG. 3A, and the fourth interior surface 344D of FIG. 3A. In the illustrated example of FIG. 6, the alternative internal configuration 600 includes a plunger 602. In the illustrated example of FIG. 6, the plunger 602 is coupled to the first interior surface 344A of FIG. 3A via the damper springs 340. In other examples, the plunger 602 can be coupled to one or more of the interior surfaces 344A, 344B, 344C, 344D via a different combination of springs. In the illustrated example of FIG. 6, the plunger 602 includes a first hole 604A and a second hole 604B. The holes 604A, 604B are through holes that extend through the plunger 602. In the illustrated example of FIG. 6, the plunger 602 includes two holes (e.g., the holes 604A, 604B, etc.). In other examples, the plunger 602 can have additional holes (e.g., holes axially aligned with the holes 604A, 604B, holes that are disposed at circumferentially different locations than the holes 604A, 604B, etc.).

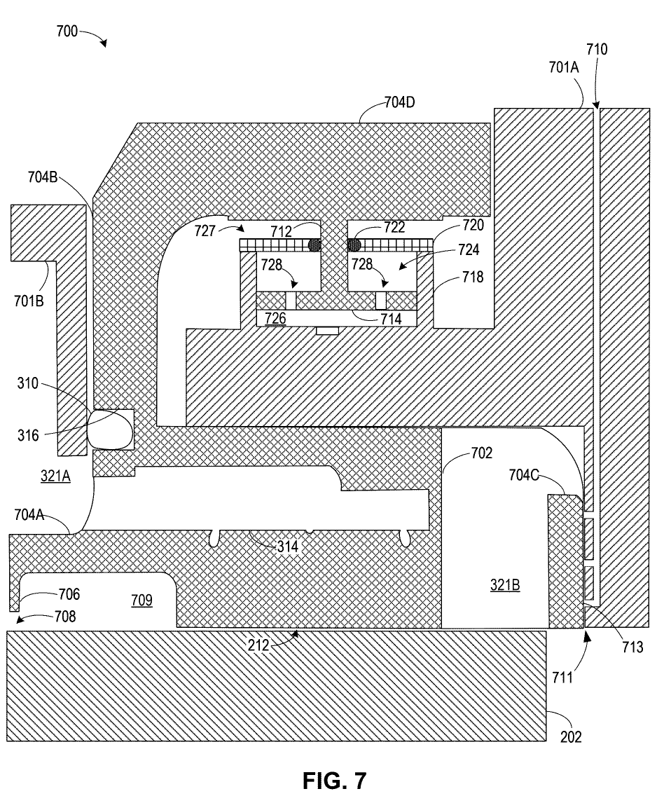

FIG. 7 is a cross-sectional view of another example damper segment 700 that may implement one of the damper segments 204 of FIG. 2 and is implemented in accordance with teachings of this disclosure. The damper segment 700 is similar to the damper segment 300 of FIG. 3A except as noted otherwise. Like the damper segment 300, the implementation of the damper segments 204 of FIG. 2 with the damper segment 700 of FIG. 7 enables the damper assembly 200 of FIG. 2 to be disposed at a mid-span location on the rotor 202 (e.g., not at a bearing location, etc.). In the illustrated example of FIG. 7, the damper segment 700 interfaces with the rotor 202 of FIG. 2 via the first thin-film interface 212 of FIGS. 2 and 3A and is disposed between the first region 321A of FIG. 3A (e.g., a high-pressure region, etc.) and the second region 321B (e.g., a low-pressure region, etc.). In the illustrated example of FIG. 7, the damper segment 700 interfaces with a first stator 701A and a second stator 701B. Like the stator 308 of FIG. 3A, one or both of the stators 701A, 701B can be a portion of the case of the gas turbine engine 110 housing the rotor 202, a stationary disk disposed around the rotor 202, etc. Additionally or alternatively, one or both of the stators 701A, 701B can be implemented by a seal housing, a carrier, and/or another stationary structure. In the illustrated example of FIG. 7, the stators 701A, 701B are discrete separate components. In other examples, the stators 701A, 701B are a single integral component.

In the illustrated example of FIG. 7, the damper segment 700 seals (e.g., restricts, prevents, etc.) the flow of air between the regions 321A, 321B. That is, the damper segment 700 is also a seal segment. In other examples, the damper segment 700 does not function as a seal (e.g., does not restrict the flow of air between the regions 321A, 321B, etc.) and only damps the radial vibration of the rotor 202 and/or the damper body 702. In the illustrated example of FIG. 7, the damper segment 700 includes a damper body 702, which includes a first body portion 704A, a second body portion 704B, a third body portion 704C, and a fourth body portion 704D. In the illustrated example of FIG. 7, the damper body 702 is a single integral (e.g., monolithic, etc.) component (e.g., the body portions 704A, 704B, 704C, 704D are portions of a single monolithic component, etc.). In other examples, the damper body 702 is an assembly composed of multiple discrete components. For example, each of the body portions 704A, 704B, 704C, 704D can be discrete components that are separately manufactured and coupled via one or more welds, one or more fasteners, one or more interference fits, etc. Additionally or alternatively, the damper body 702 can include any number of suitable components (e.g., some or all of the body portions 704A, 704B, 704C, 704D can be composed of multiple discrete components, etc.).

In the illustrated example of FIG. 7, the first body portion 704A is adjacent to the rotor 202 and includes the first internal conduit(s) 314 of FIG. 3A. In the illustrated example of FIG. 7, the first body portion 704A is radially inward of the second body portion 704B and the fourth body portion 704D. Like the damper segment 300 of FIG. 3A, the first thin-film interface 212 is generated by the flow of pressurized air through the first internal conduit(s) 314 and out of openings in the first body portion 704A onto to the rotor 202. In the illustrated example of FIG. 7, the damper segment 700 includes a lip 706 (e.g., a tooth, etc.) that extends radially inward from the first body portion 704A and defines a gap 708 between the damper body 702 and the rotor 202. The lip 706 is similar to the lip 349 of FIG. 3A, except as noted otherwise. During operation of the rotor 202 and the damper segment 700, flow between the first region 321A and the second region 321B is restricted by the gap 708, which causes an interior 709 between the rotor 202 and the first body portion 704A of the damper body 702 to be at a lower pressure than the second region 321B. The comparatively lower pressure of the interior 709 and the second region 321B compared to the first region 321A facilitates the flow of air through the first internal conduit(s) 314 and the formation of the first thin-film interface 212. In such examples, the flow of pressurized air through the first internal conduit(s) 314 is induced via the pressure differential between the first region 321A and the second region 321B. In other examples, the flow of pressurized air through the first internal conduit(s) 314 is induced via a flexible conduit coupled to the first internal conduit(s) 314 and a source of pressurized air (e.g., a bleed of a gas turbine engine 110, a compressor, etc.). In the illustrated example of FIG. 7, the rotor 202 does not include the rotor flange 301 of FIG. 3A. In other examples, the rotor 202 includes the rotor flange 301 and the first body portion 704A of the damper body 702 is shaped in a manner similar to the damper body 302 (e.g., shaped to accommodate the rotor flange 301, etc.).

The second body portion 704B extends radially between the first body portion 704A and the fourth body portion 704D. In the illustrated example of FIG. 7, the second body portion 704B is radially between the first body portion 704A and the fourth body portion 704D. The second body portion 704B couples the first body portion 704A and the third body portion 704C. In the illustrated example of FIG. 7, the second body portion 704B includes the piston bar 318 of FIG. 3A, which is disposed in the slot 316 of FIG. 3A. In the illustrated example of FIG. 7, the piston bar 318 is in contact with (e.g., abuts, interfaces with, etc.) the second stator 701B. The piston bar 318, in conjunction with the first thin-film interface 212, fluidly seals the first region 321A from the second region 321B. In some examples, friction between the piston bar 318 and the second stator 701B during the radial travel of the damper segment 700 damps (e.g., via friction damping, etc.) the damper segment 700 and the rotor 202.

The third body portion 704C axially supports the damper segment 700. In the illustrated example of FIG. 7, the third body portion 704C is adjacent to (e.g., proximate to, etc.) the first stator 701A. In the illustrated example of FIG. 7, the first stator 701A includes second internal conduit(s) 710. In the illustrated example of FIG. 7, the second internal conduit(s) 710 extend through the first stator 701A and fluidly couples the first region 321A and the second region 321B. The second internal conduit(s) 710 directs air through the first stator 701A and out of holes thereof. The high-pressure air flowing through the second internal conduit(s) 710 forms a second thin-film interface 711 between the second stator surface and a body surface 713 of the third body portion 704C. The second thin-film interface 711 opposes axial forces to maintain separation between the first stator 701A and the damper body 702 (e.g., axially locates the damper body 702, etc.), which reduces frictional forces in the radial direction therebetween. The second thin-film interface 711 facilitates the radial motion of the damper body 702. In some examples, if the damper segment 700 is a seal and there is a pressure differential between the first region 321A and the second region 321B, air is forced through the second internal conduit(s) 710 via the pressure differential therebetween. In other examples, air can be directed into the second internal conduit(s) 710 via a flexible conduit (e.g., a flexible conduit similar to the tubes 364, 368 of FIG. 3B, etc.).

In some examples, the second thin-film interface 711 is absent. In some such examples, the body surface 713 of the third body portion 704C and the first stator 701A can be coupled to and/or abut the body surface 713 and the first stator 701A. In some such examples, the abutment of the third body portion 704C and the first stator 701A and the abutment of the second body portion 704B and the second stator 701B axially locates (e.g., restrains, etc.) the damper segment 700. In the illustrated example of FIG. 7, the third body portion 704C is supported by another portion of the damper body 702 extends that circumferentially (e.g., out from the page, etc.) from another portion of the damper body 702. In other examples, the third body portion 704C can be coupled to the first body portion 704A via a rigid member (e.g., similar to the member 306 of FIG. 3A, etc.).

The fourth body portion 704D is radially outward of the first body portion 704A and the second body portion 704B. In the illustrated example of FIG. 7, the fourth body portion 704D is a flange that extends axially from the second body portion 704B. In the illustrated example of FIG. 7, the fourth body portion 704D is coupled to the member 712, which extends radially inward therefrom toward the rotor 202. In the illustrated example of FIG. 7, the member 712 extends between the fourth body portion 704D and a plunger 714. The member 712 rigidly couples the plunger 714 to the fourth body portion 704D of the damper body 702. In the illustrated example of FIG. 7, the member 712, the plunger 714, and the fourth body portion 704D are integral monolithic components. In other examples, the member 712 can be rigidly coupled to the plunger 714 and/or the fourth body portion 704D via one or more fasteners, one or more welds, one or more interference fits, etc. In the illustrated example of FIG. 7, the first stator 701A includes second internal conduit(s) 710 and a casing 718. In the illustrated example of FIG. 7, the casing 718 are coupled to a lid 720, which includes a seal 722. In the illustrated example of FIG. 7, the casing 718 and the lid 720 define a chamber 724. In the illustrated example of FIG. 7, the casing 718 is enclosed (e.g., closed on all sides, etc.). In the illustrated example of FIG. 3A, the chamber 724 is filled with a damping medium 726. In some examples, the damping medium 726 includes pressurized air, oil, hydraulic fluid, powder, and/or an aerogel. To damp vibrations transferred from the rotor 202, the damper segment 700 includes an example damper 727 implemented in accordance with teachings of this disclosure. In the illustrated example of FIG. 7, the damper 727 includes the member 712, the plunger 714, the second internal conduit(s) 710, the casing 718, and the chamber 724. The damper 727 is similar to the damper 330 of FIG. 3A, except as noted otherwise.

In the illustrated example of FIG. 7, the member 712 extends from the fourth body portion 704D, through the lid 720 and seal 722, and into the chamber 724. In some examples, the seal 722 is an elastomer seal (e.g., an O-ring, etc.), which enables the radial translation of the member 712 (e.g., with the radial translation of the rotor 202 and the damper body 702, etc.) and restricts (e.g., prevents, reduces, etc.) the flow of damper fluid through the lid 720. In the illustrated example of FIG. 7, the chamber 724 is sealed by the casing 718 and the seal 722. That is, the damping medium 726 of the damper 727 is unable to enter the second region 321B. In the illustrated example of FIG. 7, the casing 718 are a single monolithic component (e.g., monolithically formed with the first stator 701A. In other examples, the casing 718 can be multiple discrete components that are assembled. In some such examples, the chamber 724 can include one or more additional seals to prevent the flow of air into the chamber 724 and/or the flow of the damping medium 726 out of the chamber 724.

The plunger 714 is disposed within the chamber 724. Unlike the plunger 336 of FIG. 3A, the plunger 714 is not coupled to the casing 718 of the chamber (e.g., does not include the damper springs 340 of FIGS. 3A-3C, etc.) and is instead rigidly coupled to the damper body 702 via the member 712. That is, the plunger 714 travels in phase with the radial travel of the damper body 702. In the illustrated example of FIG. 7, the plunger 714 has a same shape (e.g., rectangular, etc.) as the chamber 724. In other examples, the plunger 714 can have a different shape than the chamber 724. For example, the edges of the plunger 714 can be rounded, filleted, chamfered, and/or other smoothed, and/or the surfaces of the plunger 714 can be treated (e.g., smoothed, roughened, etc.) to modify the friction associated with the flow of the damping medium 726 over the plunger 714. In the illustrated example of FIG. 7, the plunger 714 includes example openings 728, which extend through the plunger 714 (e.g., the openings 728 are through holes, etc.). Additionally or alternatively, the position of the plunger 714 within the chamber 724 forms the gaps with the casing 718 (e.g., similar to the gaps 343 of FIG. 3A, etc.).

The rigid radial coupling of the plunger 714 to damper body 702 causes the plunger 714 to radially move with damper body 702. The vibration of the rotor 202 is transferred through damper body 702 to the plunger 714 through the member 712. The vibration causes the plunger 714 to radially move relative to the first stator 701A, which forces the damping medium 726 through the openings of the plunger 714. The friction associated with the movement of the damping medium 726 over the plunger 714 and through the openings 728 heats the damping medium 726 and dissipates energy from the vibration of the damper body 702 and the rotor 202. The dissipation of energy associated with the damper 727 damps the vibration of the damper body 702 and the rotor 202, which reduces the total radial travel of the rotor 202 (e.g., the magnitude of the oscillation of the rotor 202, etc.).

From the foregoing, it will be appreciated that example systems, apparatus, articles of manufacture, and methods have been disclosed that reduce (e.g., damp, dissipate) vibration of a rotor in mechanical devices such as gas turbine engines. Examples disclosed herein include a film riding damper assembly having a plurality of damper segments, which reduces the magnitude of oscillation of the rotor and prevent potential damage to components associated with the oscillation thereof. The example dampers disclosed herein are not limited to being incorporated into bearings and can be disposed at a mid-span location on the rotor. Accordingly, the dampers disclosed herein can be located at locations on a rotor that exhibit high-magnitude oscillations. The disposition of dampers at mid-span locations increases the efficacy of the damping provided by the damper assembly. Disclosed systems, apparatus, articles of manufacture, and methods are accordingly directed to one or more improvement(s) in the operation of a machine and/or mechanical device.

Further aspects of the disclosure are provided by the subject matter of the following clauses:

A damper assembly for a rotor, the damper assembly including a body including a first surface forming a first thin-film interface with the rotor, and a second surface forming an interface with a stator, and a damper rigidly coupled to the body including an enclosed casing including a damping medium, and a plunger within the casing.

The damper assembly of any preceding clause, wherein the casing is hermetically sealed.

The damper assembly of any preceding clause, further including a first spring extending between the plunger and an interior surface of the casing.

The damper assembly of any preceding clause, further including a second spring extending between the body and the stator.

The damper assembly of any preceding clause, wherein the damper assembly is to be disposed between a high-pressure region and a low-pressure region and the body further includes an internal conduit extending between the first surface and the high-pressure region.

The damper assembly of any preceding clause, further including an internal conduit extending from the first surface, and a flexible conduit coupled to the internal conduit.

The damper assembly of any preceding clause, wherein the first surface and the second surface are substantially orthogonal.

The damper assembly of any preceding clause, further including a member rigidly coupling the damper to the body, the member extending between an exterior surface of the casing and the body.

The damper assembly of any preceding clause, further including a member rigidly coupling the damper to the body, the member extending between the plunger and the body, the member extending through the casing.

The damper assembly of any preceding clause, wherein the plunger is spaced from an interior surface of the casing.

A gas turbine engine including a shaft, and a damper assembly including a body including a first surface to form a first thin-film interface with the shaft, and a second surface to form an interface with a stator, and a damper rigidly coupled to the body including a casing including a damping medium, and a plunger within the casing.

The gas turbine engine of any preceding clause, further including a first bearing to support the shaft at a first end of the shaft, and a second bearing to support the shaft at a second end of the shaft, the damper disposed at a mid-span location of the shaft between the first bearing and the second bearing.

The gas turbine engine of any preceding clause, wherein the casing is hermetically sealed.

The gas turbine engine of any preceding clause, further including a first spring extending between the plunger and an interior surface of the casing.

The gas turbine engine of any preceding clause, further including a second spring to bias the damper assembly toward the shaft.

The gas turbine engine of any preceding clause, wherein the first surface and the second surface are substantially orthogonal.

The gas turbine engine of any preceding clause, further including a member rigidly coupling the damper to the body, the member extending between an exterior surface of the casing and the body.

The gas turbine engine of any preceding clause, further including a member rigidly coupling the damper to the body, the member extending between the plunger and the body, the member extending through the casing.

The gas turbine engine of any preceding clause, wherein the plunger includes a through hole.

The gas turbine engine of any preceding clause, wherein the damper assembly is to be disposed between a high-pressure region and a low-pressure region and the body further includes an internal conduit extending between the first surface and the high-pressure region.

The damper assembly of any preceding clause, wherein the plunger has a surface area (A) and a thickness (L), the damping medium has a dynamic viscosity (μ), the plunger is disposed a first distance (r₁) from a vertical center of the damping, the casing is disposed a second distance (r₂), and the damping coefficient of the damper (c) is defined by the following equation:

$$c = \frac{{A}^{2} 8 μ L}{π ( {r}_{2}^{2} - {r}_{1}^{2} )} [ {r}_{2}^{2} + {r}_{1}^{2} - \frac{{r}_{2}^{2} - {r}_{1}^{2}}{ln ( {r}_{2} / {r}_{1} )} ] .$$

The damper assembly of any preceding clause, wherein the damper has a first mass (m_{plunger}), the damper has a radial position (z), a radial velocity (ż), and a radial acceleration (2), the second spring has a first spring constant (k_{plunger}), the plunger has a radial position (y) and a radial velocity (\dot{y}), and the motion of the damper is defined by the following equation:

$${m}_{plunger} \ddot{z} + c \dot{z} + {k}_{{plunger}^{Z}} = c \dot{y} + {k}_{plunger} y .$$

The damper assembly of any preceding clause, wherein the casing has a second mass (m_{casing}), the plunger has a radial acceleration (ÿ), the first spring has a second spring constant (kₛₑₐₗ), the first thin-film interface exerts a first force (F(t)) on the damper and the motion of the body is defined by the following equation:

$$( {m}_{plunger} + {m}_{casing} ) \ddot{y} + c \dot{y} + ( {k}_{plunger} + {k}_{seal} ) y = c \dot{z} + {k}_{plunger} z + F ( t ) .$$

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A damper assembly for a rotor, the damper assembly comprising:
a body including:
a first surface forming a first thin-film interface with the rotor; and
a second surface forming an interface with a stator; and
a damper rigidly coupled to the body, the damper including:
an enclosed casing including a damping medium; and
a plunger within the casing.

2. The damper assembly of claim 1, wherein the casing is hermetically sealed.

3. The damper assembly of claim 1, further including a first spring extending between the plunger and an interior surface of the casing.

4. The damper assembly of claim 3, further including a second spring extending between the body and the stator.

5. The damper assembly of claim 1, wherein the damper assembly is to be disposed between a high-pressure region and a low-pressure region and the body further includes an internal conduit extending between the first surface and the high-pressure region.

6. The damper assembly of claim 1, further including:
an internal conduit extending from the first surface; and
a flexible conduit coupled to the internal conduit.

7. The damper assembly of claim 1, wherein the first surface and the second surface are substantially orthogonal.

8. The damper assembly of claim 1, further including a member rigidly coupling the damper to the body, the member extending between an exterior surface of the casing and the body.

9. The damper assembly of claim 1, further including a member rigidly coupling the damper to the body, the member extending between the plunger and the body, the member extending through the casing.

10. The damper assembly of claim 1, wherein the plunger is spaced from an interior surface of the casing.

11. A gas turbine engine, comprising:
a shaft; and
a damper assembly including:
a body including:
a first surface forming a first thin-film interface with the shaft; and
a second surface forming an interface with a stator; and
a damper rigidly coupled to the body, the damper including:
an enclosed casing including a damping medium; and
a plunger within the casing.

12. The gas turbine engine of claim 11, further including:
a first bearing to support the shaft at a first end of the shaft; and
a second bearing to support the shaft at a second end of the shaft, the damper disposed at a mid-span location of the shaft between the first bearing and the second bearing.

13. The gas turbine engine of claim 11, wherein the casing is hermetically sealed.

14. The gas turbine engine of claim 11, further including a first spring extending between the plunger and an interior surface of the casing.

15. The gas turbine engine of claim 14, further including a second spring to bias the damper assembly toward the shaft.

16. The gas turbine engine of claim 11, wherein the first surface and the second surface are substantially orthogonal.

17. The gas turbine engine of claim 11, further including a member rigidly coupling the damper to the body, the member extending between an exterior surface of the casing and the body.

18. The gas turbine engine of claim 11, further including a member rigidly coupling the damper to the body, the member extending between the plunger and the body, the member extending through the casing.

19. The gas turbine engine of claim 11, wherein the plunger includes a through hole.

20. The gas turbine engine of claim 11, wherein the damper assembly is to be disposed between a high-pressure region and a low-pressure region and the body further includes an internal conduit extending between the first surface and the high-pressure region.
